(19) United States
(12) Patent Application Publication
(10) Pub. No.: US 2026/0286849 A1
(43) Pub. Date: Sep. 24, 2026

(54) AIRFOILS FOR GAS TURBINE ENGINES

(71) Applicant: General Electric Company, Evendale, OH (US)

(72) Inventors: Harjit S. Hura, Cincinnati, OH (US); Paul Hadley Vitt, Liberty Township, OH (US)

(21) Appl. No.: 19/081,243

(22) Filed: Mar. 17, 2025

(51) Int. Cl. F01D 5/14

(52) U.S. Cl. CPC F01D 5/141; F05D 2250/71

(57) ABSTRACT

An airfoil for a gas turbine engine includes a leading edge, a trailing edge, a pressure sidewall extending between the leading edge and the trailing edge, a suction sidewall opposite the pressure sidewall and extending between the leading edge and the trailing edge, and a flared portion extending from the suction sidewall. The flared portion extends from a flare lead point towards the trailing edge. The flare lead point is downstream of a throat point on the suction sidewall. The throat point is at a minimum distance between the suction sidewall of the airfoil and another pressure sidewall of an adjacent airfoil.

### FEDERALLY SPONSORED RESEARCH

This invention was made with government support awarded by the Department of Defense. The U.S. government may have certain rights in the invention.

### FIELD

The present disclosure relates to airfoils for gas turbine engines.

### BACKGROUND

A gas turbine engine typically includes a fan and a turbomachine. The turbomachine generally includes an inlet, one or more compressors, a combustor, and at least one turbine. The compressors compress air, which is channeled to the combustor where it is mixed with fuel. The mixture is then ignited for generating hot combustion gases. The combustion gases are channeled to the turbine(s), which extract(s) energy from the combustion gases for powering the compressor(s), as well as for producing useful work to propel an aircraft in flight. The turbomachine is mechanically coupled to the fan for driving the fan during operation.

The gas turbine engine includes a plurality of stator vanes and a plurality of rotor blades. The plurality of stator vanes direct a flow of the combustion gases against the rotor blades. Each of the plurality of stator vanes include an airfoil. A portion of the flow of the combustion gases may leak over a tip of the plurality of stator vanes and rotor blades, which decreases efficiency of the gas turbine engine. Accordingly, airfoil designs for improving efficiency of gas turbine engines are desirable.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 is a cross-sectional view of a gas turbine engine in accordance with an exemplary aspect of the present disclosure.

FIG. 2 is a perspective view of a portion of an airfoil of the gas turbine engine of FIG. 1 in accordance with an exemplary aspect of the present disclosure.

FIG. 3A is a perspective view of an airfoil in accordance with an exemplary aspect of the present disclosure.

FIG. 3B is a plan view of a tip of a pair of the airfoils of FIG. 3A in accordance with an exemplary aspect of the present disclosure.

FIG. 3C is a cross-sectional view of a portion of one of the airfoils of FIG. 3B along line A-A in accordance with an exemplary aspect of the present disclosure.

FIG. 4A is a perspective view of an airfoil in accordance with an exemplary aspect of the present disclosure.

FIG. 4B is a plan view of a tip of a pair of the airfoils of FIG. 4A in accordance with an exemplary aspect of the present disclosure.

FIG. 5 is a graphical representation of a system performance index according to an exemplary embodiment of the present disclosure.

FIG. 6A is a plan view of a tip of a pair of airfoils in accordance with an exemplary aspect of the present disclosure.

FIG. 6B is a detailed view of a tip of one of the airfoils of FIG. 6A in accordance with an exemplary aspect of the present disclosure.

FIG. 6C is a cross-sectional view of a portion of one of the airfoils of FIG. 6A along line B-B in accordance with an exemplary aspect of the present disclosure.

FIG. 7A is a plan view of a tip of a pair of airfoils in accordance with an exemplary aspect of the present disclosure.

FIG. 7B is a cross-sectional view of a portion of one of the airfoils of FIG. 7A along line C-C in accordance with an exemplary aspect of the present disclosure.

FIG. 8 is a cross-sectional view of a portion of an airfoil in accordance with an exemplary aspect of the present disclosure.

FIG. 9 is a cross-sectional view of a portion of an airfoil in accordance with an exemplary aspect of the present disclosure.

FIG. 10 is a cross-sectional view of a portion of an airfoil in accordance with an exemplary aspect of the present disclosure.

FIG. 11 is a cross-sectional view of a portion of an airfoil in accordance with an exemplary aspect of the present disclosure.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

The singular forms “a,” “an,” and “the” include plural references unless the context clearly dictates otherwise.

The term “at least one of” in the context of, e.g., “at least one of A, B, and C” refers to only A, only B, only C, or any combination of A, B, and C.

The term “turbomachine” refers to a machine including one or more compressors, a heat generating section (e.g., a combustion section), and one or more turbines that together generate a torque output.

The term “turbine engine” refers to an engine having a turbomachine as all or a portion of its power source. Example turbine engines include turbofan engines, open rotor engines, turboprop engines, turbojet engines, turboshaft engines, etc., as well as hybrid-electric versions of one or more of these engines.

The term “combustion section” refers to any heat addition system for a turbomachine. For example, the term combustion section may refer to a section including one or more of a deflagrative combustion assembly, a rotating detonation combustion assembly, a pulse detonation combustion assembly, or other appropriate heat addition assembly. In certain example embodiments, the combustion section may include an annular combustor, a can combustor, a cannular combustor, a trapped vortex combustor (TVC), or other appropriate combustion system, or combinations thereof.

The terms “forward” and “aft” refer to relative positions within a gas turbine engine or vehicle, and are based on a normal operational attitude of the gas turbine engine or vehicle. More particularly, forward and aft are used herein with reference to a direction of travel of the vehicle and a direction of propulsive thrust of the gas turbine engine.

The terms “upstream” and “downstream” refer to the relative direction with respect to fluid flow in a fluid pathway.

As used herein, the terms “axial” and “axially” refer to directions and orientations that extend substantially parallel to a centerline of the gas turbine engine. Moreover, the terms “radial” and “radially” refer to directions and orientations that extend substantially perpendicular to the centerline of the gas turbine engine. In addition, as used herein, the terms “circumferential” and “circumferentially” refer to directions and orientations that extend arcuately about the centerline of the gas turbine engine.

As used herein, a “bypass ratio” of a turbine engine is a ratio of bypass air through a bypass of the turbine engine to core air through a core inlet of a turbomachine of the turbine engine. For example, the bypass ratio is a ratio of bypass air entering the bypass airflow passage to core air entering the turbomachine.

The terms “coupled,” “fixed,” “attached to,” and the like refer to both direct coupling, fixing, or attaching, as well as indirect coupling, fixing, or attaching through one or more intermediate components or features, unless otherwise specified herein.

As used herein, the terms “first,” “second,” and “third” may be used interchangeably to distinguish one component from another and are not intended to signify location or importance of the individual components.

For purposes of the description hereinafter, the terms “upper,” “lower,” “right,” “left,” “vertical,” “horizontal,” “top,” “bottom,” “lateral,” “longitudinal,” and derivatives thereof shall relate to the embodiments as they are oriented in the drawing figures. However, it is to be understood that the embodiments may assume various alternative variations, except where expressly specified to the contrary. It is also to be understood that the specific devices illustrated in the attached drawings, and described in the following specification, are simply exemplary embodiments of the disclosure. Hence, specific dimensions and other physical characteristics related to the embodiments disclosed herein are not to be considered as limiting.

The term “adjacent” as used herein with reference to two walls and/or surfaces refers to the two walls and/or surfaces contacting one another, or the two walls and/or surfaces being separated only by one or more nonstructural layers and the two walls and/or surfaces and the one or more nonstructural layers being in a serial contact relationship (i.e., a first wall/surface contacting the one or more nonstructural layers, and the one or more nonstructural layers contacting a second wall/surface).

As used herein, the term “complementary” with reference to a radius of curvature of two radii of curvature, refers to the two radii of curvature being equal, or a larger of two the radii of curvature being no more than 10% greater than a smaller of the two radii of curvature.

Generally, a gas turbine engine includes a fan and a turbomachine, with the turbomachine rotating the fan to generate thrust. The turbomachine includes a compressor section, a combustion section, a turbine section, and an exhaust section and defines a working gas flow path therethrough. The turbine section includes a plurality of airfoils for directing the flow of combustion gases therethrough. The plurality of airfoils include a suction side and an opposing pressure side extending axially between a leading edge and a trailing edge and radially between a root and a tip. In operation a portion of the combustion gases pass over the tip of the plurality of airfoils as a leakage flow. The leakage flow is weaker than the remaining airflow flowing through the plurality of airfoils due to its lower velocity. The leakage flow cannot produce useful turbine work and will result in performance loss. Thus, the leakage flow results in a loss of efficiency and results additional losses, such as excess fuel burn.

The inventors of the present disclosure sought out a means to reduce the leakage flow over the tip of the plurality of airfoils in order to improve turbine efficiency. The inventors developed a winglet or flare for placing on the suction side of the plurality of airfoils adjacent the tip. In particular, the inventors proceeded in the manner of designing a plurality of airfoils for a gas turbine engine where the flare starts at a point downstream from the leading edge and, more particularly, aft of a throat of the plurality of airfoils. Aft of the throat is where most of the leakage of the combustion gases over the tip occurs. The throat is a minimum distance between adjacent airfoils.

Airfoil designs discussed below include a winglet or flare where the cost and weight penalty associated with positioning the winglet or flare aft of the throat is overcome by efficiency benefit, contrary to previous thinking and expectations. In addition, positioning the winglet or flare aft of the throat does not require re-sizing the plurality of airfoils. Moreover, such a winglet or flare may be retrofitted to existing airfoils for improved turbine efficiency and engine performance.

Gas turbine engines with the plurality of airfoils having the winglet or flare (including the configurations illustrated and described herein) are characterized by an airfoil radius of the plurality of airfoils, a rotational speed of the plurality of airfoils, a maximum offset or thickness of the flare from the suction side of the plurality of airfoils at the tip, and a minimum distance between adjacent ones of the plurality of airfoils at the tip. The flare on the plurality of airfoils of the turbine section results in a net benefit to overall engine design. Accordingly, the improved gas turbine engine improves turbine efficiency while minimizing increases in weight.

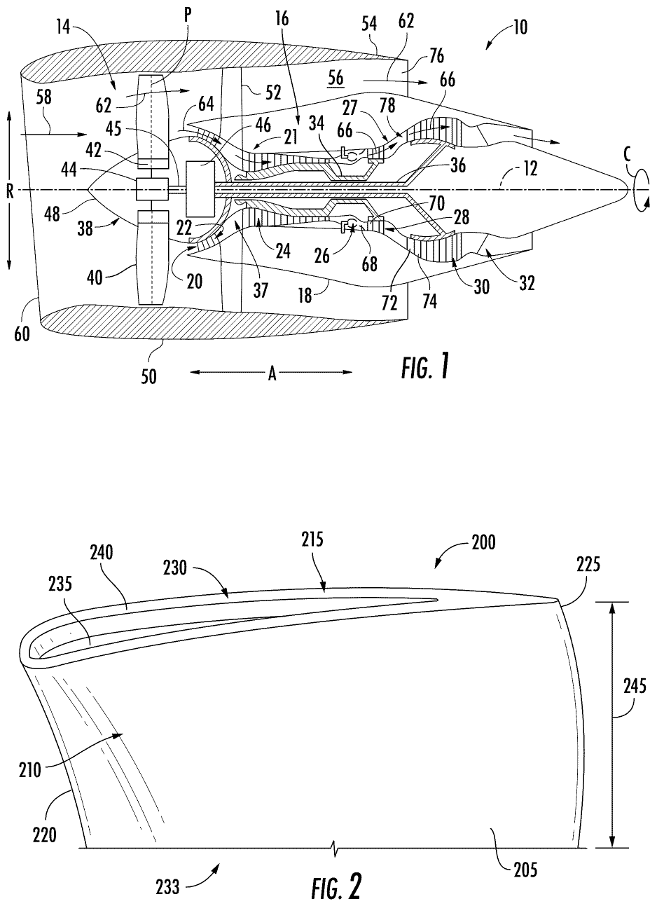

Referring now to the drawings, FIG. 1 is a cross-sectional view of a gas turbine engine 10 in accordance with an exemplary aspect of the present disclosure.

As shown in FIG. 1, the gas turbine engine 10 has an axial direction A (extending parallel to a longitudinal centerline axis 12) and a radial direction R that is perpendicular to the axial direction A. In general, the gas turbine engine 10 includes a fan section 14 and a turbomachine 16 disposed downstream from the fan section 14.

The turbomachine 16 includes an outer casing 18 that is substantially tubular and defines an annular core inlet 20. As schematically shown in FIG. 1, the outer casing 18 encases, in serial flow relationship, a compressor section 21 including a booster or a low-pressure compressor (“LPC”) 22 followed downstream by a high-pressure compressor (“HPC”) 24, a combustion section 26, a turbine section 27, including a high-pressure turbine (“HPT”) 28, followed downstream by a low-pressure turbine (“LPT”) 30, and one or more core exhaust nozzles 32. A high-pressure (“HP”) shaft 34 or a spool drivingly connects the HPT 28 to the HPC 24 to rotate the HPT 28 and the HPC 24 in unison. The HPT 28 is drivingly coupled to the HP shaft 34 to rotate the HP shaft 34 when the HPT 28 rotates. A low-pressure (“LP”) shaft 36 drivingly connects the LPT 30 to the LPC 22 to rotate the LPT 30 and the LPC 22 in unison. The LPT 30 is drivingly coupled to the LP shaft 36 to rotate the LP shaft 36 when the LPT 30 rotates. The compressor section 21, the combustion section 26, the turbine section 27, and the one or more core exhaust nozzles 32 together define a core gas flow path 33.

For the embodiment depicted in FIG. 1, the fan section 14 includes a fan 38 (e.g., a variable pitch fan) having a plurality of fan blades 40 coupled to a disk 42 in a spaced apart manner. As depicted in FIG. 1, the fan blades 40 extend outwardly from the disk 42 generally along the radial direction R. Each fan blade 40 is rotatable relative to the disk 42 about a pitch axis P by virtue of the fan blades 40 being operatively coupled to an actuator 44 configured to collectively vary the pitch of the fan blades 40 in unison. The fan blades 40, the disk 42, and the actuator 44 are rotatable together about the longitudinal centerline axis 12 via a fan shaft 45 that is powered by the LP shaft 36 across a power gearbox, also referred to as a gearbox assembly 46. The gearbox assembly 46 is shown schematically in FIG. 1. The gearbox assembly 46 includes a plurality of gears for adjusting the rotational speed of the fan shaft 45 and, thus, the fan 38 relative to the LP shaft 36.

Referring still to the exemplary embodiment of FIG. 1, the disk 42 is covered by a rotatable fan hub 48 aerodynamically contoured to promote an airflow through the plurality of fan blades 40. In addition, the fan section 14 includes an annular fan casing or a nacelle 50 that circumferentially surrounds the fan 38 and/or at least a portion of the turbomachine 16. The nacelle 50 is supported relative to the turbomachine 16 by a plurality of circumferentially spaced outlet guide vanes 52. Moreover, a downstream section 54 of the nacelle 50 extends over an outer portion of the turbomachine 16 to define a bypass airflow passage 56 therebetween. The one or more core exhaust nozzles 32 may extend through the nacelle 50 and be formed therein. In this exemplary embodiment, the one or more core exhaust nozzles 32 include one or more discrete nozzles that are spaced circumferentially about the nacelle 50. Other arrangements of the core exhaust nozzles 32 may be used including, for example, a single core exhaust nozzle that is annular, or partially annular, about the nacelle 50.

During operation of the gas turbine engine 10, a volume of air 58 enters the gas turbine engine 10 through an inlet 60 of the nacelle 50 and/or the fan section 14. As the volume of air 58 passes across the fan blades 40, a first portion of air (bypass air 62) is directed or routed into the bypass airflow passage 56, and a second portion of air (core air 64) is directed or is routed into the upstream section of the core gas flow path 33, or, more specifically, into the annular core inlet 20. The ratio between the first portion of air (bypass air 62) and the second portion of air (core air 64) is known as a bypass ratio. In some embodiments, the bypass ratio is greater than 18:1. The pressure of the core air 64 is then increased by the LPC 22, generating compressed air 65, and the compressed air 65 is routed through the HPC 24 and further compressed before being directed into the combustion section 26, where the compressed air 65 is mixed with fuel and burned to generate combustion gases 66 (combustion products). One or more stages may be used in each of the LPC 22 and the HPC 24, with each subsequent stage further compressing the compressed air 65. The HPC 24 has a compression ratio greater than 20:1, preferably, in a range of 20:1 to 40:1. The compression ratio is a ratio of a pressure of a last stage of the HPC 24 to a pressure of a first stage of the HPC 24. The compression ratio may be greater than 20:1.

The combustion gases 66 are routed into the HPT 28 and expanded through the HPT 28 where a portion of thermal energy and/or kinetic energy from the combustion gases 66 is extracted via sequential stages of HPT stator vanes 68 that are coupled to the outer casing 18 and HPT rotor blades 70 that are coupled to the HP shaft 34, thus, causing the HP shaft 34 to rotate, which supports operation of the HPC 24. The combustion gases 66 are then routed into the LPT 30 and expanded through the LPT 30. Here, a second portion of thermal energy and/or the kinetic energy is extracted from the combustion gases 66 via sequential stages of LPT stator vanes 72 that are coupled to the outer casing 18 and LPT rotor blades 74 that are coupled to the LP shaft 36, thus, causing the LP shaft 36 to rotate, which supports operation of the LPC 22 and rotation of the fan 38 via the gearbox assembly 46. One or more stages may be used in each of the HPT 28 and the LPT 30. The HPC 24 having a compression ratio in a range of 20:1 to 40:1 enables the HPT 28 to have a pressure expansion ratio in a range of 1.5:1 to 4:1 and the LPT 30 having a pressure expansion ratio in a range of 4.5:1 to 28:1.

The combustion gases 66 are routed through the one or more core exhaust nozzles 32 of the turbomachine 16 to provide propulsive thrust. Simultaneously with the flow of the core air 64 through the core gas flow path 33, the bypass air 62 is routed through the bypass airflow passage 56 before being exhausted from a fan bypass nozzle 76 of the gas turbine engine 10, also providing propulsive thrust. The HPT 28, the LPT 30, and the one or more core exhaust nozzles 32 at least partially define a hot gas path 78 for routing the combustion gases 66 through the turbomachine 16.

As noted above, the compressed air 65 (the core air 64) is mixed with the fuel in the combustion section 26 to generate a fuel and air mixture, and combusted, generating combustion gases 66 (combustion products). The fuel can include any type of fuel used for turbine engines, such as, for example, sustainable aviation fuels (SAF) including biofuels, JetA, or other hydrocarbon fuels. In other example embodiments, the fuel may be a hydrogen-based fuel (H₂), such as hydrogen-based fuel which may include blends with hydrocarbon fuels. In still other example embodiments, the hydrogen fuel may comprise substantially pure hydrogen molecules (i.e., diatomic hydrogen). The fuel may also be a cryogenic fuel. For example, when the hydrogen fuel is used, the hydrogen fuel may be stored in a liquid phase at cryogenic temperatures.

The gas turbine engine 10 depicted in FIG. 1 is by way of example only. In other exemplary embodiments, the gas turbine engine 10 may have any other suitable configuration. For example, in other exemplary embodiments, the fan 38 may be configured in any other suitable manner (e.g., as a fixed pitch fan) and further may be supported using any other suitable fan frame configuration. Moreover, in other exemplary embodiments, any other suitable number or configuration of compressors, turbines, shafts, or a combination thereof may be provided. In still other exemplary embodiments, aspects of the present disclosure may be incorporated into any other suitable turbine engine, such as, for example, turbofan engines (as shown in FIG. 1), open rotor engines (e.g., a gas turbine engine similar to the turbofan engine of FIG. 1, but without the outer nacelle surrounding the fan), propfan engines, turboprop engines, ground power generation machines, or a combination thereof.

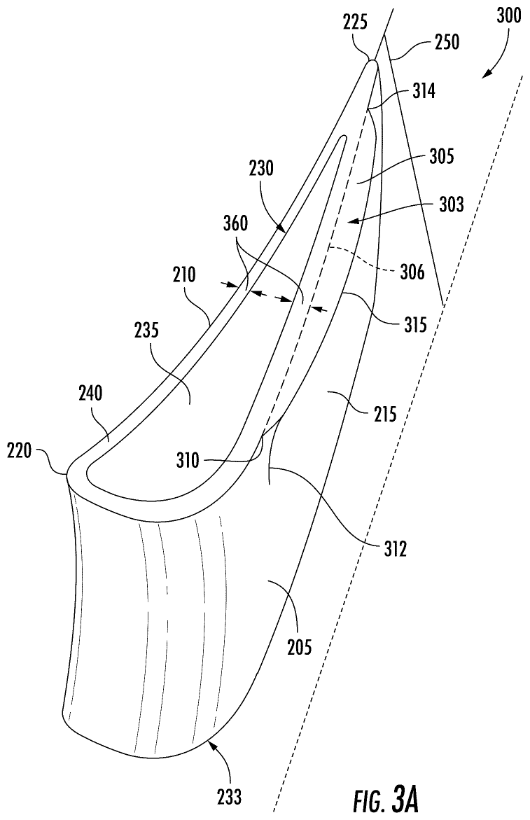

FIG. 2 is a perspective view of a portion of an airfoil 200 of the gas turbine engine 10 of FIG. 1 in accordance with an exemplary aspect of the present disclosure. The airfoil 200 may be one or more of a plurality of rotor blades of a turbine section of a gas turbine engine, such as the turbine section 27 of the gas turbine engine 10 discussed with respect to FIG. 1. More specifically, the airfoil 200 may be one or more of the HPT rotor blades 70 of the HPT 28 of the turbine section 27. Additionally, the airfoil 200 may be one or more of the LPT rotor blades 74.

The airfoil 200 includes an airfoil body 205 having a pressure sidewall 210 and a suction sidewall 215 opposite the pressure sidewall 210. The pressure sidewall 210 is connected to the suction sidewall 215 at a leading edge 220 of the airfoil 200 and a trailing edge 225 downstream of the leading edge 220. Accordingly, the airfoil body 205 of the airfoil 200 extends between the leading edge 220 and the trailing edge 225. The pressure sidewall 210 defines a generally concave external surface of the airfoil 200, and the suction sidewall 215 defines a generally convex external surface of the airfoil 200.

Moreover, the pressure sidewall 210 and the suction sidewall 215 extend in the radial direction R (FIG. 1) from an airfoil root 233 to an airfoil tip 230. The airfoil root 233 may be adjacent a central hub of the turbine section 27. Additionally, the airfoil tip 230 generally defines the radially outermost portion of the airfoil 200 and, thus, is configured to be positioned adjacent to a stationary shroud or seal (not shown) of the gas turbine engine 10. The airfoil 200 has an airfoil height 245 extending between the airfoil root 233 and the airfoil tip 230. Moreover, the airfoils height 245 defines a span of the airfoil 200 where the airfoil root is at 0% of the span of the airfoil 200 and the airfoil tip 230 is at 100% of the span of the airfoil 200. In some example embodiments, as shown in FIG. 2, the airfoil tip 230 may define a plenum or cavity, such as the plenum 235. In the illustrated embodiment, the plenum 235 is surrounded by a sidewall 240 defined by the airfoil body 205 of the airfoil 200. In other example embodiments, no plenum is defined by the airfoil tip 230.

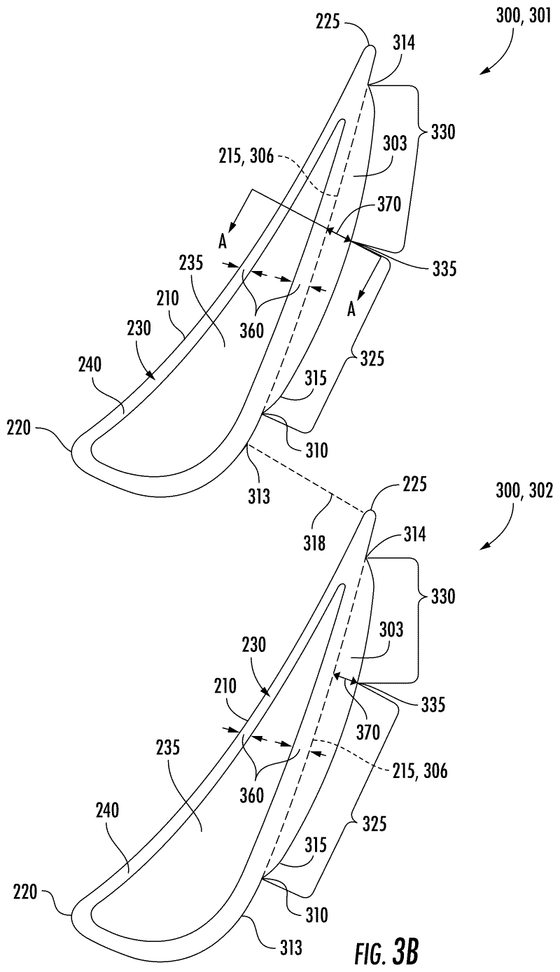

FIG. 3A is a perspective view of an airfoil 300 in accordance with an exemplary aspect of the present disclosure. FIG. 3B is a view of a tip of a pair of the airfoils 300 of FIG. 3A in accordance with an exemplary aspect of the present disclosure. FIG. 3C is a cross-sectional view of a portion of one of the airfoils 300 of FIG. 3B along line A-A in accordance with an exemplary aspect of the present disclosure. Each of the airfoils 300 may be similar or analogous to the exemplary airfoil 200 discussed with respect to FIG. 2. For example, each of the airfoils 300 include the airfoil body 205 having the pressure sidewall 210, the suction sidewall 215, the leading edge 220, the trailing edge 225, the airfoil tip 230, and the airfoil root 233. Each of the airfoils 300 may also include the plenum 235 disposed at the airfoil tip 230. Accordingly, FIG. 3B illustrates a view of the airfoil tip 230 of the airfoils 300. Moreover, the airfoils 300 may be incorporated into the turbine section 27 of the gas turbine engine 10 discussed with respect to FIG. 1 as one or more of the plurality of HPT rotor blades 70.

In at least one example embodiment, one or more of the airfoils 300 include a flared portion 303 extending from the suction sidewall 215 adjacent the airfoil tip 230. The flared portion 303 is configured to change a flow of the combustion gases 66 such that a flow of the combustion gases 66 over the airfoil tip 230 as a leakage flow is reduced. Moreover, the flared portion 303 experiences reduced pressure losses such that an improvement in downstream air pressure is realized. As a result, fuel consumption by the gas turbine engine 10 may also be reduced. Accordingly, efficiency and performance of the gas turbine engine 10 is improved.

As shown in FIG. 3C, a dashed line 306 illustrates where traditional airfoils end along the suction sidewall 215. Moreover, the plenum 235 is surrounded by the sidewall 240. With reference to FIG. 3C, the plenum 235 is defined between a pressure side inner wall 350 and a suction side inner wall 355 of the sidewall 240. The sidewall 240 also includes a sidewall thickness 360. For example, the sidewall thickness 360 extends between the pressure sidewall 210 and the pressure side inner wall 350 and extends between the suction sidewall 215 and the suction side inner wall 355. Accordingly, as shown in FIGS. 3A-3C, the flared portion 303 extends beyond the sidewall thickness 360 of the sidewall 240 defined between the suction side inner wall and the dashed line 306 (representing the suction sidewall 215).

Each of the airfoils 300 define an airfoil radius 250 extending from the longitudinal centerline axis 12 to the airfoil tip 230. Moreover, the sidewall thickness 360 adjacent the pressure sidewall 210 and the suction sidewall 215 may be the same or equal in some example embodiments. In other example embodiments, the sidewall thickness 360 adjacent the pressure sidewall and the suction sidewall 215 may be different.

In additional example embodiments, the flared portion 303 may be retrofitted to existing gas turbine engines. For example, one or more airfoils of existing gas turbine engines may be replaced with the airfoils 300 including the flared portion 303. More specifically, in some example embodiments, the flared portion 303 is constructed as a single unitary part or component (e.g., a monolithic structure) with the airfoil body 205. For example, the airfoil body 205 and the flared portion 303 can be molded or machined as a single part or component. In other example embodiments, the flared portion 303 may be a separate part or component that is coupled (e.g., welded) to the airfoil body 205.

With reference to FIG. 3B, which illustrates a top view of the airfoil tip 230, the flared portion 303 extends between a flare lead point 310 and a flare end point 314 adjacent the trailing edge 225. In at least one example embodiment, as shown in FIG. 3B, the flare lead point 310 and the flare end point 314 may be positioned between the leading edge 220 and the trailing edge 225. For example, the flare end point 314 is forward of the trailing edge 225. In other example embodiments, the flare end point 314 may be positioned at the trailing edge 225 such that the flared portion 303 extends from the flare lead point 310 to the trailing edge 225.

Moreover, the flare lead point 310, and thus the flared portion 303, is downstream of a throat point 313 positioned along the suction sidewall 215. The throat point 313 is a point where a distance 318 between adjacent ones of the airfoils 300 is smallest (also referred to as a throat of the airfoils 300). For example, the exemplary airfoils 300 illustrated in FIG. 3B are a plurality of airfoils including a first airfoil 301 and a second airfoil 302 spaced from the first airfoil 301. The throat point 313 is a point along the suction sidewall 215 of the first airfoil 301 where the distance 318 between the suction sidewall 215 of the first airfoil 301 and the pressure sidewall 210 of the second airfoil 302 is smallest or at a minimum. Additionally, as shown in FIG. 3B, the flared portion 303 may define a generally convex curve extending between the flare lead point 310 and the flare end point 314.

In other example embodiments, the flare lead point 310 may be at the throat point 313 such that the flared portion 303 extends from the flare lead point 310 and the throat point 313 to the flare end point 314. In such embodiments, both the throat point 313 and the flare lead point 310 may be a point where the distance 318 between the flared portion 303 at the airfoil tip 230 and the pressure sidewall 210 of the second airfoil 302 is smallest or at a minimum.

Referring again to FIG. 3C, the flared portion 303 includes a flare top face 305 and a flare bottom face 312. The flare top face 305 extends from the airfoil tip 230. For example, the flare top face 305 may be flush with the airfoil tip 230. In at least one example embodiment, the flare bottom face 312 includes a fillet extending from and along the suction sidewall 215 to an end of the flare top face 305. For example, the flare bottom face 312 defines a concave curve extending from the suction sidewall 215 to an outer flare edge 315 of the flare top face 305. In other example embodiments, the flare bottom face 312 may define a convex shape or any other shape extending between the suction sidewall 215 and the outer flare edge 315 of the flare top face.

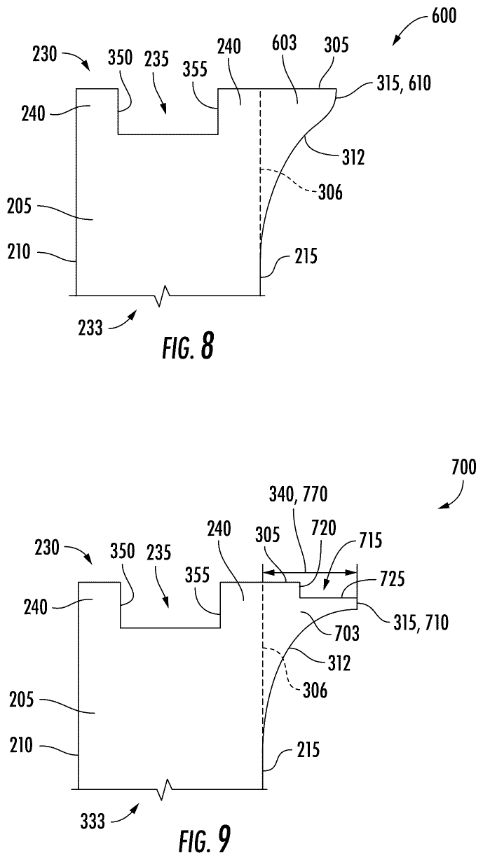

The flared portion 303 includes a flare span 320 extending in the radial direction R between the airfoil root 233 and the airfoil tip 230. For example, the flare span 320 is within the span or airfoil height 245 discussed above with respect to FIG. 2. In at least one example embodiment, the flare span 320 may be within 75% to 100% of the airfoil height 245, or the span extending from the airfoil root 233 to the airfoil tip 230, as discussed with respect to FIG. 2. Moreover, the flare span 320 may be within 90% to 100% of the airfoil height 245, or the span extending from the airfoil root 233 to the airfoil tip 230, as discussed with respect to FIG. 2, in some example embodiments. In additional example embodiments, such as will be discussed with respect to FIG. 10 below, at least a portion of the flare span 320 may extend to a position below 100% of the airfoil height 245 or the span extending from the airfoil root 233 to the airfoil tip 230.

with reference to FIG. 3B, the flared portion 303 includes a first flare segment 325 and a second flare segment 330 at the airfoil tip 230 and extending between the flare lead point 310 and the flare end point 314. For example, the first flare segment 325 extends from the flare lead point 310 to a flare point 335, and the second flare segment 330 extends from the flare point 335 to the flare end point 314. The first flare segment 325 and the second flare segment 330 extend along the outer flare edge 315. The flare point 335 is between the flare lead point 310 and the flare end point 314. In some examples, the flare point 335 is a point along the flared portion 303 at which a thickness of the flared portion 303 changes, as will be discussed below.

Moreover, as shown in FIG. 3B, the flared portion 303 defines a maximum thickness 370 between the suction sidewall 215 and the outer flare edge 315 at the airfoil tip 230. The maximum thickness 370 is a maximum of a flare thickness 340 (FIG. 3C) at the airfoil tip 230. In at least one example embodiment, the maximum thickness 370 may be positioned at the flare point 335.

As shown in FIG. 3C, the flare thickness 340 (and the maximum thickness 370) extends from the suction sidewall 215 to the outer flare edge 315 of the flared portion 303. For example, the flare thickness 340 extends perpendicular to the suction sidewall 215. Moreover, the flare thickness 340 extends from the dashed line 306 illustrating where traditional airfoils end along the suction sidewall 215. The flare thickness 340 of the flared portion 303 may increase along the first flare segment 325 from the flare lead point 310 to the flare point 335, and the flare thickness 340 of the flared portion 303 may decrease along the second flare segment 330 from the flare point 335 to the flare end point 314. For example, as shown in FIG. 3A, the flare thickness 340 at the flare lead point 310 may be about 0, and the flare thickness 340 at the flare end point 314 may be about 0. In at least one example embodiment, the maximum thickness 370, which is the maximum of the flare thickness 340 of the flared portion 303, is greater than 0 and less than or equal to 0.5 times, or 50% of, the distance 318. More specifically, the maximum thickness 370, may be greater than 0 and less than or equal to 0.3 times, or 30% of, the distance 318. Additionally, a ratio of the flare thickness 340 divided by the distance 318 is less than or equal to 1. More specifically, the ratio of the flare thickness 340 divided by the distance 318 may be less than or equal to 0.3.

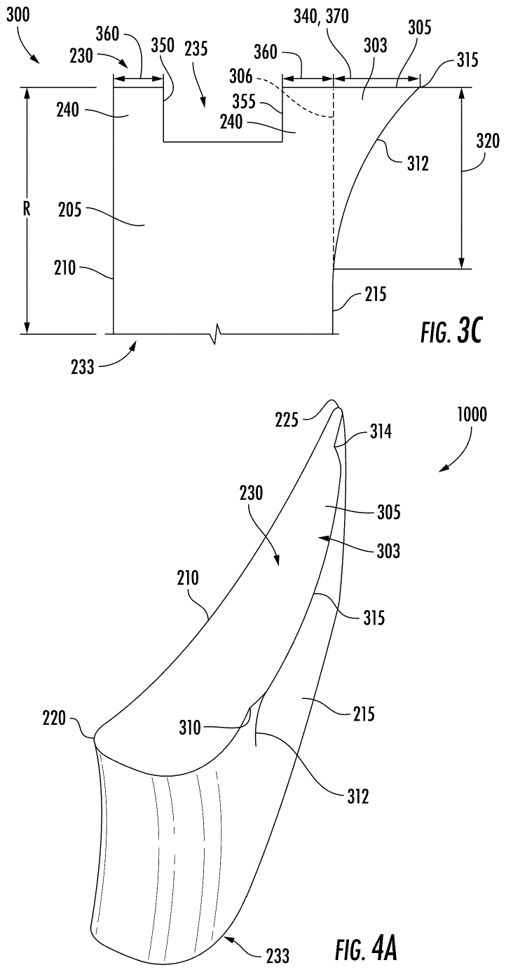

FIG. 4A is a perspective view of an airfoil 1000 in accordance with an exemplary aspect of the present disclosure. FIG. 4B is a plan view of a tip of a pair of the airfoils 1000 of FIG. 4A in accordance with an exemplary aspect of the present disclosure. Each of the airfoils 1000 may be similar or analogous to the exemplary airfoils 300 discussed with respect to FIGS. 3A-3C. For example, each of the airfoils 1000 include the airfoil body 205 having the pressure sidewall 210, the suction sidewall 215, the leading edge 220, the trailing edge 225, the airfoil tip 230, and the airfoil root 233. However, in contrast to the airfoils 300 discussed with respect to FIGS. 3A-3C, the airfoils 1000 do not include the plenum 235. Moreover, the airfoils 1000 may be incorporated into the turbine section 27 of the gas turbine engine 10 discussed with respect to FIG. 1 as one or more of the plurality of HPT rotor blades 70. Additionally, a combination of the airfoils 300 and the airfoils 1000 discussed herein may be incorporated into the turbine section 27 of the gas turbine engine 10 discussed with respect to FIG. 1 as one or more of the plurality of HPT rotor blades 70 in some example embodiments.

As shown in FIGS. 4A-4B, the airfoils 1000 includes the flared portion 303 extending from the suction sidewall 215. In at least one example embodiment, the airfoils 1000 define a reference line 1005 (FIG. 4B) at the airfoil tip 230 extending from the throat point 313 to a suction side tangency point 1010 adjacent the trailing edge 225. The flared portion 303 extends from the reference line 1005 generally perpendicularly to the suction sidewall 215. Accordingly, the flared portion 303 defines a maximum thickness 1070 between the reference line 1005 and the outer flare edge 315 at the airfoil tip 230. Similar to the maximum thickness 370 discussed above with respect to FIGS. 3A-3C, the maximum thickness 1070 is a maximum of the flare thickness 340 at the airfoil tip 230. In at least one example embodiment, the maximum thickness 1070 may be positioned at the flare point 335.

As alluded to earlier, the inventors developed multiple airfoil assemblies with each of the airfoils having a flared portion and determined that a ratio of a minimum distance (D_{o_tip}) between the suction sidewall 215 of one of the airfoils 300 and the pressure sidewall 210 of an adjacent one of the airfoils 300 at the airfoil tip 230 and a maximum flare distance (d_{tip_max}) of the flared portion 303 at the airfoil tip 230 have a significant effect on turbine efficiency.

In particular, the inventors discovered that inclusion of the plurality of airfoils having the flared portion increases turbine efficiency without detrimentally increasing weight. For example, the flared portion is positioned at the tip and aft of the throat of the plurality of airfoils, which limits the amount of weight added to the tip of the airfoils due to less material being added to the airfoil. Conversely, positioning the flared portion forward of the throat blocks flow areas, which requires throat re-sizing due to bearing load and airfoil durability considerations. Additionally, increasing a ratio of the maximum thickness or offset of the flare portion at the tip over the minimum distance between adjacent ones of the plurality of airfoils at the tip reduces the amount of combustion gases leaking over the airfoil tip, which improves turbine efficiency and thus overall engine performance.

As stated above, the inventors created solutions for a gas turbine engine with a plurality of airfoils having a flared portion beginning downstream of the leading edge capable of achieving improved turbine efficiency and suited for a particular mission requirement, one that takes into account efficiency, weight, thermal capacity needs, complexity, reliability, and other factors influencing the optimal choice for a gas turbine engine with airfoils having a flared portion. Table 1 below illustrates 21 examples (denoted Ex. 1-21) of gas turbine engines 10 and airfoils 300 developed by the inventors. Table 1 includes values for d_{tip_max} divided by D_{o_tip}

$$( \frac{{d}_{tip \_ max}}{{D}_{o \_ tip}} )$$

represented by a percentage.

TABLE 1

| Parameter | $\frac{{d}_{tip \_ max}}{{D}_{o \_ tip}}$ |
|---|---|
| Units | % |
| Ex. 1 | 15 |
| Ex. 2 | 11 |
| Ex. 3 | 10 |
| Ex. 4 | 0.1 |
| Ex. 5 | 20 |
| Ex. 6 | 0.2 |
| Ex. 7 | 7.5 |
| Ex. 8 | 22 |
| Ex. 9 | 5 |
| Ex. 10 | 0.05 |
| Ex. 11 | 25 |
| Ex. 12 | 0.25 |
| Ex. 13 | 0.5 |
| Ex. 14 | 28.1 |
| Ex. 15 | 0 |
| Ex. 16 | 35 |
| Ex. 17 | 40 |
| Ex. 18 | 45 |
| Ex. 19 | 50 |
| Ex. 20 | 55 |
| Ex. 21 | 60 |

The inventors found that airfoil designs with parameters defined in Examples 1-14 exhibit improved turbine efficiency while remaining within current engine constraints. Conversely, Examples 15-21 exhibit penalties due to increased weight, which negatively impacts turbine efficiency.

The examples developed by the inventors shown in Table 1 can be characterized by a system performance index (ξ) and a base system performance index (ξ_{base}) that can be used to identify designs that meet the performance (turbine efficiency) requirements from designs that do not meet the performance requirements. The system performance index (ξ) and the base system performance index (ξ_{base}) are based on a value δ, described below with respect to Expression (2). The base system performance index (ξ_{base}) is determined based on the value δ being equal to 0. A normalized system performance index (ξ/ξ_{base}) can be used to identify an improved airfoil design including a flare portion, better suited for a particular engine operating environment and taking into account the constraints imposed on airfoil design with flare portions in such a system.

The ξ/ξ_{base} is defined in Expression (1) below as follows:

$$ξ / {ξ}_{b a s e} = ( 1 + 30 ln ( δ ) ) - ( 26.4 ( δ - 1 ) ) \qquad ( 1 )$$

The δ of (1) is defined as follows:

$$δ = [ 1 + \frac{{d}_{tip \_ max}}{{D}_{{o}_{tip}}} ] \qquad ( 2 )$$

Accordingly, ξ/ξ_{base} of (1) can be re-written using (2) as follows:

$$ξ / {ξ}_{base} = ( 1 + 30 ln ( [ 1 + \frac{{d}_{tip \_ max}}{{D}_{{o}_{tip}}} ] ) ) - ( 26.4 ( [ 1 + \frac{{d}_{tip \_ max}}{{D}_{{o}_{tip}}} ] - 1 ) )$$

The maximum flare distance (d_{tip_max}) of (2) is the maximum thickness 370, 1070, such as where the flare thickness 340 is at a maximum at the airfoil tip 230, and the minimum distance (D_{o_tip}) of (2) is the distance 318 at the airfoil tip 230, as discussed with respect to FIGS. 3A-4B. The measure for both the maximum flare distance (d_{tip_max}) and the minimum distance (D_{o_tip}) may be in feet, inches, or centimeters.

Values for ξ/ξ_{base} for each of the examples of Table 1 are shown in Table 2. It should be understood that for the calculation of ξ/ξ_{base} for each of the examples the

$$\frac{{d}_{tip \_ max}}{{D}_{o \_ tip}}$$

values was converted from a percentage to a decimal, as shown in Table 2.

TABLE 2

| Parameter | $\frac{{d}_{tip max}}{{D}_{o \_ tip}}$ | $\frac{{d}_{tip \_ max}}{{D}_{o \_ tip}} / 100$ | ξ/ξ_{base} |
|---|---|---|---|
| Units | % | n/a | n/a |
| Ex. 1 | 15 | 0.15 | 1.232858 |
| Ex. 2 | 11 | 0.11 | 1.2268 |
| Ex. 3 | 10 | 0.1 | 1.219305 |
| Ex. 4 | 0.1 | 0.001 | 1.219305 |
| Ex. 5 | 20 | 0.2 | 1.189647 |
| Ex. 6 | 0.2 | 0.002 | 1.189647 |
| Ex. 7 | 7.5 | 0.075 | 1.18962 |
| Ex. 8 | 22 | 0.22 | 1.157526 |
| Ex. 9 | 5 | 0.05 | 1.143705 |
| Ex. 10 | 0.05 | 0.0005 | 1.143705 |
| Ex. 11 | 25 | 0.25 | 1.094307 |
| Ex. 12 | 0.25 | 0.0025 | 1.094307 |
| Ex. 13 | 0.5 | 0.005 | 1.017626 |
| Ex. 14 | 28.1 | 0.281 | 1.010831 |
| Ex. 15 | 0 | 0 | 1 |
| Ex. 16 | 35 | 0.35 | 0.763138 |
| Ex. 17 | 40 | 0.4 | 0.534167 |
| Ex. 18 | 45 | 0.45 | 0.266907 |
| Ex. 19 | 50 | 0.5 | −0.03605 |
| Ex. 20 | 55 | 0.55 | −0.37235 |
| Ex. 21 | 60 | 0.6 | −0.73989 |

Based on the ξ/ξ_{base} values in Table 2, it was determined that gas turbine engine and airfoil design with a ξ/ξ_{base} value in the range of 1.01 to 1.24 (i.e., 1.01<ξ/ξ_{base}<1.24). Such benefits include increasing turbine efficiency without detrimentally increasing weight. This provides for increased durability of the airfoils 300, which decreases required maintenance and costs, while increasing overall engine reliability and performance.

Further still, the benefits included herein provide for airfoils 300, and more particularly flare portions 305, that fits within existing engines. For example, the values for ξ/ξ_{base} as provided herein take existing engines into consideration, permitting replacement of current airfoils with replacement airfoils (or new airfoils) having the flare portion or adding the flare portions to current airfoils having the parameters of the airfoils and flare portion described herein. Such consideration provides for replacing and improving current engine systems without requiring the creation of new engine parts capable of holding the airfoils and the flare portion. This provides for improving current engine durability without increasing costs to prepare new engines or further adapt existing engines.

Table 3 below illustrates minimum and maximum values for the

$$\frac{{d}_{tip \_ max}}{{D}_{o \_ tip}}$$

along with a range of values for ξ/ξ_{base} suited for airfoils having a flare portion that meet efficiency and performance requirements.

TABLE 3

| Parameter: | Element: | Minimum: | Maximum: | Units: |
|---|---|---|---|---|
| $\frac{{D}_{o \_ tip}}{{d}_{tip \_ max}}$ | Ratio of the maximum flare | 0.005 (0.5%) | 0.282 (28.2%) | n/a |
| | distance (dₜᵢₚ_max) | | | |
| | over the | | | |
| | minimum | | | |
| | distance (Dₒ_tip) | | | |
| ξ/ξ_{base} | Ratio of the | 1.01 | 1.24 | n/a |
| | system | | | |
| | performance | | | |
| | index (ξ) over the | | | |
| | base system | | | |
| | performance | | | |
| | index (ξ_{base}) | | | |

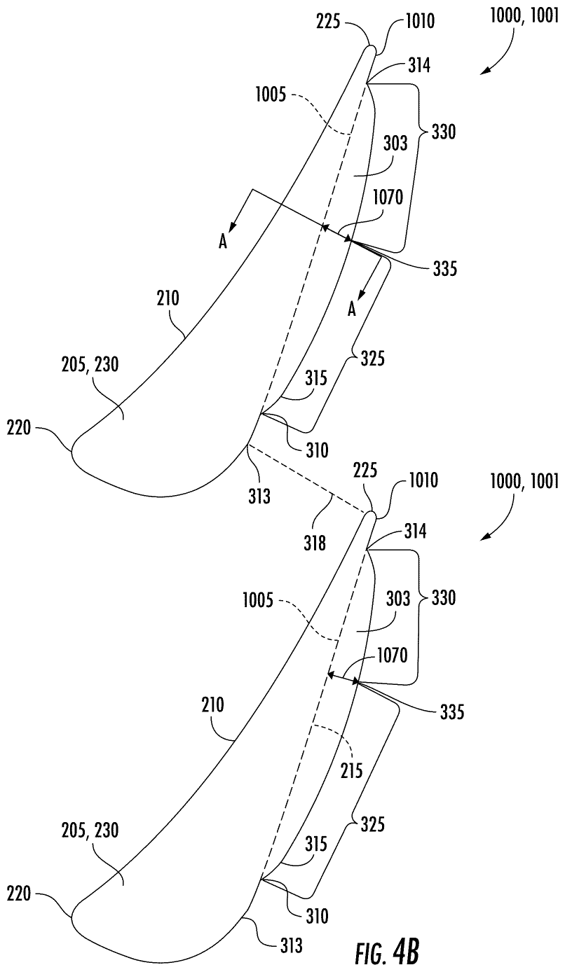

FIG. 5 provides a graph 1100 depicting the ξ/ξ_{base} as a function of

$$\frac{{D}_{o \_ tip}}{{d}_{tip \_ max}} .$$

For example, the graph 1100 provides

$$\frac{{D}_{o \_ tip}}{{d}_{tip \_ max}} ,$$

expressed as a percentage on the X-axis 1105 and provides ξ/ξ_{base} on the Y-axis 1110. The graph 1100 includes a line 1115 indicating a relationship between ξ/ξ_{base} and

$$\frac{{D}_{o \_ tip}}{{d}_{tip \_ max}} .$$

The graph 1100 also depicts a range 1120 where ξ/ξ_{base} is greater than 1.01 and less than 1.24 and where

$$\frac{{D}_{o \_ tip}}{{d}_{tip \_ max}}$$

is greater than or equal to 0.5% (0.005 as shown in Table 3) and less than or equal to 28.2% (0.282 as shown in Table 3). Values outside the range 1120 are undesirable due to the decline of ξ/ξ_{base}.

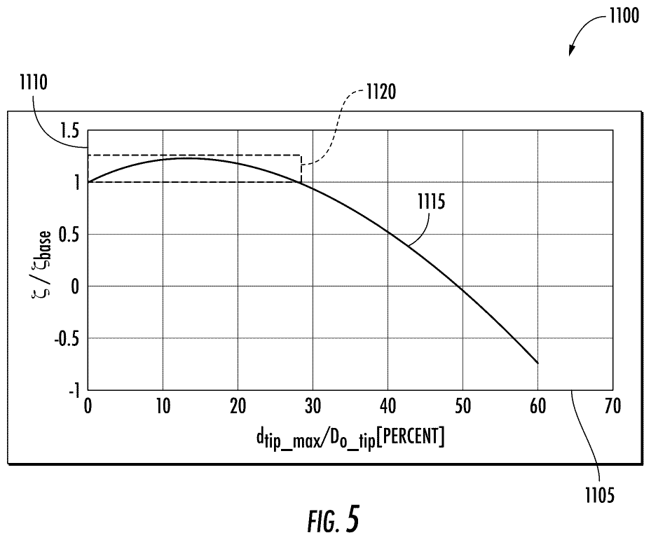

FIG. 6A is a plan view of a tip of a pair of airfoils 400 in accordance with an exemplary aspect of the present disclosure. FIG. 6B is a detailed view of the tip of one of the airfoils 400 of FIG. 6A in accordance with an exemplary aspect of the present disclosure. FIG. 6C is a cross-sectional view of a portion of one of the airfoils 400 of FIG. 6A along line B-B in accordance with an exemplary aspect of the present disclosure. The airfoils 400 may be similar or analogous to the exemplary airfoils 200, 300, 1000 discussed above with respect to FIGS. 2-4B. For example, the airfoils 400 include the airfoil body 205 having the pressure sidewall 210, the suction sidewall 215, the leading edge 220, the trailing edge 225, the airfoil tip 230, and the airfoil root 233. In some example embodiments, the airfoils 400 may include the plenum 235 disposed at the airfoil tip 230, as shown with respect to the airfoils 300 in FIGS. 3A-3C. Additionally, the airfoils 400 may be incorporated into the turbine section 27 of the gas turbine engine 10 discussed with respect to FIG. 1 as one or more of the plurality or rotor blades. Moreover, a combination of the airfoils 300, the airfoils 1000, and/or the airfoils 400 discussed herein may be incorporated into the turbine section 27 of the gas turbine engine 10 discussed with respect to FIG. 1 as one or more of the plurality of HPT rotor blades 70 in some example embodiments.

The airfoils 400 include a flared portion 403 extending from the suction sidewall 215 adjacent the airfoil tip 230. The dashed line 306 illustrates where traditional airfoils end along the suction sidewall 215. The flared portion 403 may be similar or analogous to the flared portion 303 discussed above with respect to FIGS. 3A-4B. For example, the flared portion 403 extends from the flare lead point 310 towards the trailing edge 225 and is downstream of the throat point 313. The flared portion 403 also includes the flare top face 305 extending from the airfoil tip 230 of the airfoil 400 to the outer flare edge 315 and the flare bottom face 312 extending from and along the suction sidewall 215 to the outer flare edge 315. As shown in FIG. 6C, the flare bottom face 312 includes a fillet defining a generally concave curve extending from the suction sidewall 215 to the outer flare edge 315 of the flare top face 305. In other example embodiments, the flare bottom face 312 may define a convex shape or any other shape extending between the suction sidewall 215 and the outer flare edge 315 of the flare top face.

In at least one example embodiment, the flared portion 403 also includes the first flare segment 325 and the second flare segment 330 extending between the flare lead point 310 and the trailing edge 225. For example, the first flare segment 325 extends from the flare lead point 310 to a flare point 335 and the second flare segment 330 extends from the flare point 335 to the trailing edge 225. The first flare segment 325 and the second flare segment 330 extend along the outer flare edge 315. The flare point 335 may be between the flare lead point 310 and the trailing edge 225.

With reference to FIG. 6A, the outer flare edge 315 of the flared portion 403 of one or more of the airfoils 400 may define a general convex curve extending between the flare lead point 310 and the trailing edge 225. Additionally, or alternatively, as shown with respect to the first airfoil 401, the second flare segment 330 of one or more of the airfoils 400 may extend generally linearly from the flare point 335 to the aft edge 405. In such example embodiments, the flared portion 403 of the first airfoil 401 may define a maximum offset 470 between the suction sidewall 215 and the outer flare edge 315 adjacent the trailing edge 225. The maximum offset 470 may be a maximum of the flare thickness 340 extending along the first flare segment 325 and the second flare segment 330.

As shown in FIG. 6C, the flared portion 403 includes the flare thickness 340 extending from the suction sidewall 215 to the outer flare edge 315. The flare thickness 340 of the flared portion 403 may increase along the first flare segment 325 from the flare lead point 310 towards the flare point 335, and the flare thickness 340 may also increase along the second flare segment 330 from the flare point 335 towards the trailing edge 225 relative to the suction sidewall 215, as shown in FIG. 6A with respect to the first airfoil 401.

Moreover, the second flare segment 330 may extend from the flare point 335 to an aft edge 405 of the flared portion 403. For example, the aft edge 405 may extend between the trailing edge 225 and the outer flare edge 315 of the second flare segment 330. As shown in FIG. 6A, the flared portion 403 may include a curved portion between the outer flare edge 315 of the second flare segment 330 and the aft edge 405. For example, the aft edge 405 defines a general convex curve from the second flare segment 330 to the trailing edge 225. Alternatively, the outer flare edge 315 of the second flare segment 330 and the aft edge 405 may be substantially perpendicular, as shown in FIG. 6B.

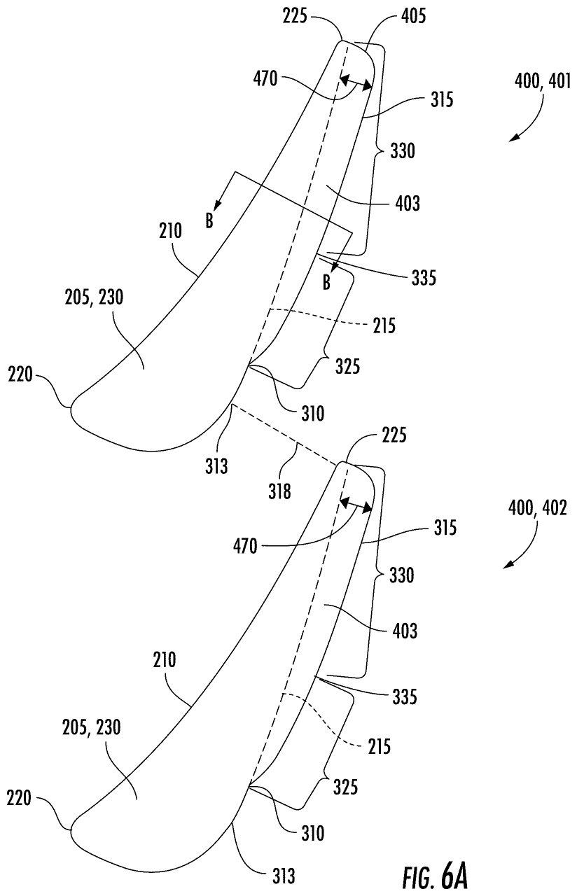

FIG. 7A is a plan view of a tip of a pair of airfoils 500 in accordance with an exemplary aspect of the present disclosure. FIG. 7B is a cross-sectional view of a portion of one of the airfoils 300 of FIG. 7A along line C-C in accordance with an exemplary aspect of the present disclosure. The airfoils 500 may be similar or analogous to the exemplary airfoils 200, 300, 1000, 400 discussed above with respect to FIGS. 2-4B and 6A-6C. For example, the airfoils 500 include the airfoil body 205 having the pressure sidewall 210, the suction sidewall 215, the leading edge 220, the trailing edge 225, the airfoil tip 230, and the airfoil root 233. In some example embodiments, the airfoils 500 may include the plenum 235 disposed at the airfoil tip 230, as shown with respect to the airfoils 300 in FIGS. 3A-3C. Additionally, the airfoils 400 may be incorporated into the turbine section 27 of the gas turbine engine 10 discussed with respect to FIG. 1 as one or more of the plurality or rotor blades. Moreover, a combination of the airfoils 300, the airfoils 1000, the airfoils 400, and/or the airfoils 500 discussed herein may be incorporated into the turbine section 27 of the gas turbine engine 10 discussed with respect to FIG. 1 as one or more of the plurality of HPT rotor blades 70 in some example embodiments.

The airfoils 500 include a flared portion 503 extending from the suction sidewall 215 adjacent the airfoil tip 230. The dashed line 306 illustrates where traditional airfoils end along the suction sidewall 215. The flared portion 503 may be similar or analogous to the exemplary flared portions 303, 403 discussed above with respect to FIGS. 3A-4B and 6A-6C. For example, the flared portion 503 extends from the flare lead point 310 towards the trailing edge 225 and is downstream of the throat point 313. The flared portion 503 also includes the flare top face 305 extending from the airfoil tip 230 of the airfoil 500 to the outer flare edge and the flare bottom face 312 extending from and along the suction sidewall 215 to the outer flare edge 315. As shown in FIG. 7B, the flare bottom face 312 includes a fillet defining a generally concave curve extending from the suction sidewall 215 to the outer flare edge 315. In other example embodiments, the flare bottom face 312 may define a convex shape or any other shape extending between the suction sidewall 215 and the outer flare edge 315 of the flare top face.

In at least one example embodiment, the flared portion 503 also includes the first flare segment 325 and the second flare segment 330 extending along the outer flare edge 315 between the flare lead point 310 and the trailing edge 225. For example, the first flare segment 325 extends from the flare lead point 310 to a flare point 535 and the second flare segment 330 extends from the flare point 535 towards the trailing edge 225. The flare point 535 may be between the flare lead point 310 and the trailing edge 225. Moreover, as shown in FIG. 7A, the second flare segment 330 may define an aft face 505 extending from the flare point 535 to the trailing edge 225.

As shown in FIG. 7B, the flared portion 503 includes the flare thickness 340 extending from the suction sidewall 215 to the outer flare edge 315. With reference to FIG. 7A, the flare thickness 340 of the flared portion 503 may increase along the first flare segment 325 from the flare lead point 310 towards the flare point 535. Additionally, the flare thickness 340 may decrease along the second flare segment 330, or along the aft face 505, from the flare point 535 towards the trailing edge 225. As shown in FIG. 7A, the first flare segment 325 may define a relatively convex curve extending along the outer flare edge 315. Moreover, the second flare segment 330, or the aft face 505, of the flared portion 503 may define a general concave curve. In other example embodiments, the first flare segment 325 may include a first portion defining a relatively convex curve from the lead point 310 and a second portion extending generally linearly from the convex curve to the flare point 335.

In at least one example embodiment, the flared portion 503 may define a maximum offset 570 between the suction sidewall 215 and the outer flare edge 315. The maximum offset 570 may be a maximum of the flare thickness 340. As shown in FIG. 7A, the maximum offset 570 may be at the flare point 535 in some example embodiments.

Referring again to FIG. 7B, the flared portion 503 includes a flare sidewall 510. For example, the flare sidewall 510 extends perpendicularly between the flare top face 305 and the flare bottom face 312 at the outer flare edge 315. Additionally, the flare sidewall 510 may extend extends along a length of the flared portion 503, such as along the first flare segment 325, the second flare segment 330, and the aft face 505. Moreover, a height of the flare sidewall 510 may vary along the length of the flared portion 503, such as along the first flare segment 325, the second flare segment 330, and the aft face 505.

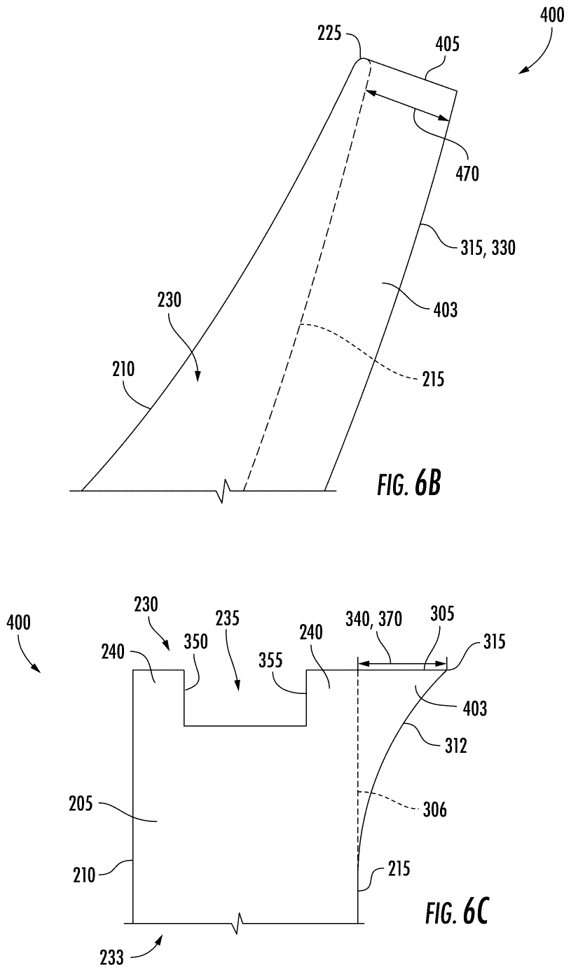

FIG. 8 is a cross-sectional view of a portion of an airfoil 600 in accordance with an exemplary aspect of the present disclosure. The airfoil 600 may be similar or analogous to the exemplary airfoils 200, 300, 1000, 400, 500 discussed above with respect to FIGS. 2-4B and 6A-7B. For example, the airfoil 600 includes the airfoil body 205 having the pressure sidewall 210, the suction sidewall 215, the leading edge 220, the trailing edge 225, the airfoil tip 230, and the airfoil root 233. Additionally, the airfoil 600 may be incorporated into the turbine section 27 of the gas turbine engine 10 discussed with respect to FIG. 1 as one or more of the plurality or rotor blades. Moreover, a combination of the airfoils 300, the airfoils 1000, the airfoils 400, the airfoils 500, and/or the airfoil 600 discussed herein may be incorporated into the turbine section 27 of the gas turbine engine 10 discussed with respect to FIG. 1 as one or more of the plurality of HPT rotor blades 70 in some example embodiments.

The airfoil 600 also includes a flared portion 603 extending from the suction sidewall 215 adjacent the airfoil tip 230 of the airfoil 600. The dashed line 306 illustrates where traditional airfoils end along the suction sidewall 215. The flared portion 603 may be similar or analogous to the exemplary flared portions 303, 403, 503 discussed above with respect to FIGS. 3A-4B and 6A-7B. For example, the flared portion 603 includes the flare top face 305 extending from the airfoil tip 230 of the airfoil 600 to the outer flare edge 315 and the flare bottom face 312 extending from and at least partially along the suction sidewall 215 to the outer flare edge 315. As shown in FIG. 8, the flared portion 603 also includes a flare sidewall 610 extending perpendicularly between the flare top face 305 and the flare bottom face 312 at the outer flare edge. Moreover, the flare bottom face 312 may define a substantially concave curve from the suction sidewall 215 towards the flare sidewall 610, and the flare sidewall 610 may define a substantially convex curve from the flare bottom face 312 to the flare top face 305.

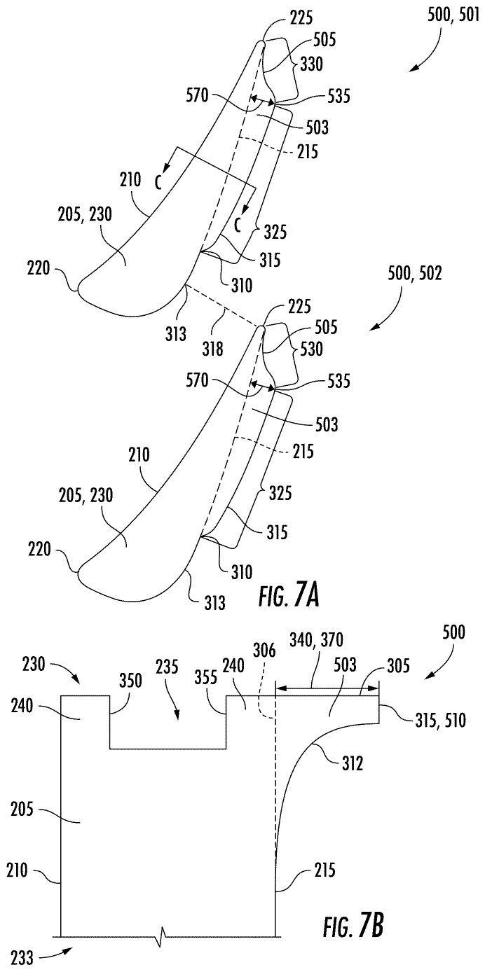

FIG. 9 is a cross-sectional view of a portion of an airfoil 700 in accordance with an exemplary aspect of the present disclosure. The airfoil 700 may be similar or analogous to the exemplary airfoils 200, 300, 1000, 400, 500, 600 discussed above with respect to FIGS. 2-4B and 6A-9. For example, the airfoil 700 includes the airfoil body 205 having the pressure sidewall 210, the suction sidewall 215, the leading edge 220, the trailing edge 225, the airfoil tip 230, and the airfoil root 233. Additionally, the airfoil 700 may be incorporated into the turbine section 27 of the gas turbine engine 10 discussed with respect to FIG. 1 as one or more of the plurality or rotor blades. Moreover, a combination of the airfoils 300, the airfoils 1000, the airfoils 400, the airfoils 500, the airfoils 600, and/or the airfoil 700 discussed herein may be incorporated into the turbine section 27 of the gas turbine engine 10 discussed with respect to FIG. 1 as one or more of the plurality of HPT rotor blades 70 in some example embodiments.

The airfoil 700 also includes a flared portion 703 extending from the suction sidewall 215 adjacent the airfoil tip 230 of the airfoil 700. The dashed line 306 illustrates where traditional airfoils end along the suction sidewall 215. The flared portion 703 may be similar or analogous to the exemplary flared portions 303, 403, 503, 603 discussed above with respect to FIGS. 3A-4B and 6A-8. For example, the flared portion 703 includes the flare top face 305 extending from the airfoil tip 230 of the airfoil 700 to the outer flare edge 315 and the flare bottom face 312 extending from and at least partially along the suction sidewall 215 to the outer flare edge 315. As shown in FIG. 9, the outer flare edge 315 of the flared portion 703 also includes a flare sidewall 710 extending perpendicular to flare top face 305 and the flare bottom face 312. The flare sidewall 710 may be similar or analogous to the flare sidewall 510, 610 discussed with respect to FIGS. 7B-8. Moreover, the flare bottom face 312 may define a substantially concave curve from the suction sidewall 215 towards the flare sidewall 610 and the outer flare edge 315.

As shown in FIG. 9, the flared portion 703 includes the flare thickness 340 extending from the suction sidewall 215 to the outer flare edge 315. Additionally, the flared portion 703 defines a maximum offset 770 between the suction sidewall 215 and the outer flare edge 315. The maximum offset 570 may be a maximum of the flare thickness 340, as discussed with respect to FIGS. 3A-4B.

In at least one example embodiment, at least a portion of the flared portion 703 may be within greater than or equal to 75% and less than or equal to 100% of the airfoil height 245 or the span discussed with respect to FIG. 2. For example, at least a portion of the flare top face 305 may be below the airfoil tip 230 such that at least a portion of the flared portion 703 is within less than 100% of the span and not flush with the airfoil tip 230. Moreover, at least a portion of the flared portion 703 may be within greater than or equal to 90% and less than or equal to 100% of the airfoil height 245 or the span.

As shown in FIG. 9, the flared portion 703 may include a step portion 715 disposed between the suction sidewall 215 and the outer flare edge 315. For example, the flared portion 703 may include a step sidewall 720 extending perpendicularly from the flare top face 305 and a step base wall 725 extending perpendicularly from the step sidewall 720 to the outer flare edge 315. The step sidewall 720 may be spaced from the suction sidewall 215 a distance less than the flare thickness 340. Moreover, the step sidewall 720 and the flare sidewall 710 may be substantially parallel.

FIG. 10 is a cross-sectional view of a portion of an airfoil 800 in accordance with an exemplary aspect of the present disclosure. The airfoil 800 may be similar or analogous to the exemplary airfoils 200, 300, 1000, 400, 500, 600, 700 discussed above with respect to FIGS. 2-4B and 6A-9. For example, the airfoil 800 includes the airfoil body 205 having the pressure sidewall 210, the suction sidewall 215, the leading edge 220, the trailing edge 225, the airfoil tip 230, and the airfoil root 233. Additionally, the airfoil 800 may be incorporated into the turbine section 27 of the gas turbine engine 10 discussed with respect to FIG. 1 as one or more of the plurality or rotor blades. Moreover, a combination of the airfoils 300, the airfoils 1000, the airfoils 400, the airfoils 500, the airfoils 600, the airfoil 700, and/or the airfoil 800 discussed herein may be incorporated into the turbine section 27 of the gas turbine engine 10 discussed with respect to FIG. 1 as one or more of the plurality of HPT rotor blades 70 in some example embodiments.

The airfoil 800 also includes a flared portion 803 extending from the suction sidewall 215 adjacent the airfoil tip 230 of the airfoil 800. The flared portion 803 may be similar or analogous to the exemplary flared portions 303, 403, 503, 603, 703 discussed above with respect to FIGS. 3A-4B and 6A-9. For example, the flared portion 803 includes the flare top face 305 extending from the airfoil tip 230 of the airfoil 800 to the outer flare edge 315 and the flare bottom face 312 extending from the suction sidewall 215 to the flare top face 305 at the outer flare edge 315. Moreover, the flared portion 803 may be defined by the sidewall 240 of the airfoil 800 adjacent the suction sidewall 215. For example, the airfoil body 205 and the flared portion 803 may be a unitary body in some example embodiments.

A dashed line 806 illustrates where traditional airfoils end along the suction sidewall 215. Accordingly, the sidewall 240 includes a sidewall thickness 860 extending between the dashed line 806 and a point 808 where the suction side inner wall 355 intersects a base wall 810 of the plenum 235. Additionally, the flared portion 803 includes the flare thickness 340 extending from the dashed line 806 to the outer flare edge 315. For example, the flared portion 803 defines a maximum offset 870 between the dashed line 806 and the outer flare edge 315. The maximum offset 870 may be a maximum of the flare thickness 340, as discussed with respect to FIGS. 3A-4B.

As shown in FIG. 10, the flare bottom face 312 defines a generally concave curve extending between the outer flare edge 315 and the suction sidewall 215. Additionally, the suction side inner wall 355 of the sidewall 240 may define a generally convex curve. For example, a curvature of the suction side inner wall 355 may correspond or be complementary to a curvature of the flare bottom face 312. In at least one example embodiment, the curvature of the flare bottom face 312 and the suction side inner wall 355 reduces an overall thickness such that weight is also reduced.

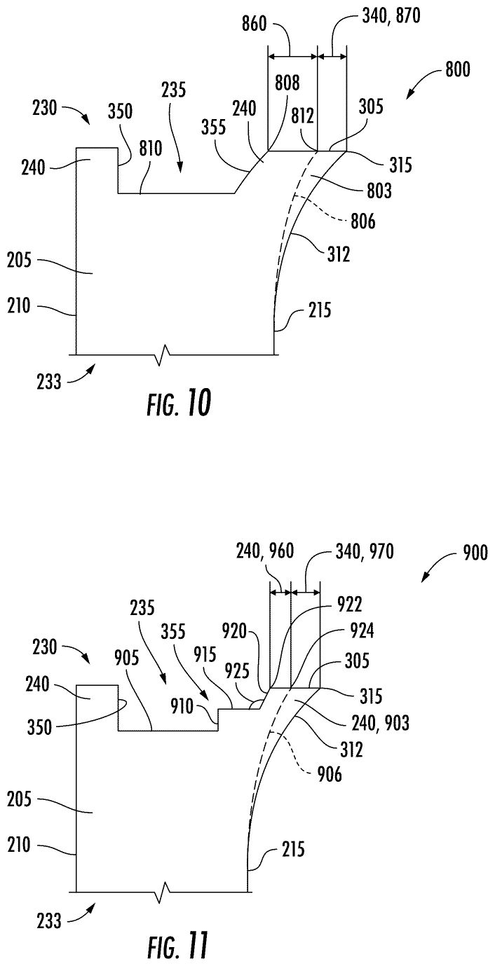

FIG. 11 is a cross-sectional view of a portion of an airfoil 900 in accordance with an exemplary aspect of the present disclosure. The airfoil 900 may be similar or analogous to the exemplary airfoils 200, 300, 1000, 400, 500, 600, 700, 800 discussed above with respect to FIGS. 2-4B and 6A-10. For example, the airfoil 900 includes the airfoil body 205 having the pressure sidewall 210, the suction sidewall 215, the leading edge 220, the trailing edge 225, the airfoil tip 230, and the airfoil root 233. Additionally, the airfoil 900 may be incorporated into the turbine section 27 of the gas turbine engine 10 discussed with respect to FIG. 1 as one or more of the plurality or rotor blades. Moreover, a combination of the airfoils 300, the airfoils 1000, the airfoils 400, the airfoils 500, the airfoils 600, the airfoil 700, the airfoil 800, and/or the airfoil 900 discussed herein may be incorporated into the turbine section 27 of the gas turbine engine 10 discussed with respect to FIG. 1 as one or more of the plurality of HPT rotor blades 70 in some example embodiments.

The airfoil 900 also includes a flared portion 903 extending from the suction sidewall 215 adjacent the airfoil tip 230 of the airfoil 900. The flared portion 903 may be similar or analogous to the exemplary flared portions 303, 403, 503, 603, 703, 803 discussed above with respect to FIGS. 3A-4B and 6A-10. For example, the flared portion 903 includes the flare top face 305 extending from the airfoil tip 230 of the airfoil 900 to the outer flare edge 315 and the flare bottom face 312 extending from the suction sidewall 215 to the flare top face 305 at the outer flare edge 315. Moreover, the flared portion 903 may be defined by the sidewall 240 of the airfoil 900 adjacent the suction sidewall 215. For example, the airfoil body 205 and the flared portion 903 may be a unitary body. As shown in FIG. 11, the flare bottom face 312 defines a generally concave curve extending between the outer flare edge 315 and the suction sidewall 215.

In at least one example embodiment, the suction side inner wall 355 includes a step portion extending between a base wall 905 of the plenum 235 and the flare top face 305. For example, the suction side inner wall 355 includes a first wall portion 910 extending from the base wall 905 of the plenum 235, a second wall portion 915 extending from an end the first wall portion 910, and a third wall portion 920 extending from an end of the second wall portion 915 opposite the first wall portion 910. Accordingly, the pressure side inner wall 350, the base wall 905, the first wall portion 910, the second wall portion 915, and the third wall portion 920 define the plenum 235. Moreover, the step portion extending between a base wall 905 of the plenum 235 and the flare top face 305 may define the sidewall 240 and include a sidewall thickness 960 extending between the first wall portion 910 and the third wall portion 920. For example, a dashed line 906 illustrates where traditional airfoils end along the suction sidewall 215. Accordingly, the sidewall thickness 960 adjacent the flared portion 903 extends between the dashed line 906 and the first wall portion 910. Additionally, the flared portion 903 includes the flare thickness 340 extending from the third wall portion 920 to the outer flare edge 315. For example, the flare thickness 340 extends between the dashed line 906 to the outer flare edge 315. Moreover, the flared portion 903 defines a maximum offset 970 between the dashed line 906 and the outer flare edge 315. The maximum offset 970 may be a maximum of the flare thickness 340, as discussed with respect to FIGS. 3A-4B.

In other example embodiments, the third wall portion 920 defines a curved surface between the second wall portion 915 and the flare top face 305. For example, the third wall portion 920 may define a general convex curve. Moreover, a curvature of the third wall portion 920 may correspond or be complementary to a curvature of the flare bottom face 312.

Accordingly, airfoils for gas turbine engines having flared portions are disclosed herein. For example, the flared portion may extend along a portion of the suction sidewall of the airfoils for creating a desirable aerodynamic effect, which increases engine performance and efficiency. More particularly, the flared portion may extend along the suction sidewall from a flare lead point downstream from a leading edge of the airfoil toward a trailing edge of the airfoil. The flare lead point may be a point along the suction sidewall of the airfoil where a distance between an adjacent airfoil is smallest.

Further aspects are provided by the subject matter of the following clauses:

Accordingly, the present disclosure provides a plurality of airfoils including a winglet or flare for reducing leakage of combustion gases over the tip of the plurality of airfoils.

A gas turbine engine, comprising: a fan; and a turbomachine operably coupled to the fan for driving the fan, the turbomachine comprising a compressor section, a combustion section, and a turbine section disposed in serial flow order along a centerline axis and together defining a working gas flow path, the turbine section comprising a plurality of airfoils extending into the working gas flow path from an airfoil root to an airfoil tip, each airfoil of the plurality of airfoils comprising: a leading edge, a trailing edge, a pressure sidewall extending between the leading edge and the trailing edge, and a suction sidewall opposite the pressure sidewall and extending between the leading edge and the trailing edge, and a flared portion extending from the suction sidewall to an outer flare edge, the flared portion extending from a flare lead point towards the trailing edge, wherein the flare lead point is downstream of a throat point on the suction sidewall at the airfoil tip, and wherein the throat point is at a minimum distance (D_{o_tip}) between the suction sidewall of the airfoil and another pressure sidewall of an adjacent airfoil; wherein the flared portion defines a maximum flare distance (d_{tip_max}) at the airfoil tip, the maximum flare distance (d_{tip_max}) being a maximum of a thickness of the flare portion at the airfoil tip and extending between the suction sidewall and the outer flare edge; and wherein:

$$1.01 < ( 1 + 30 ln ( [ 1 + \frac{{d}_{tip \_ max}}{{D}_{{o}_{tip}}} ] ) ) - ( 26.4 ( [ 1 + \frac{{d}_{tip \_ max}}{{D}_{{o}_{tip}}} ] - 1 ) ) <$$

1.24.

The gas turbine engine of any preceding clause, wherein

$$\frac{{d}_{tip \_ max}}{{D}_{{o}_{tip}}}$$

is greater than or equal to 0.005 (0.5%) and less than or equal to 0.282 (28.2%).

The gas turbine engine of any preceding clause, wherein the turbine section comprises a plurality of stator vanes and a plurality of rotor blades, and wherein the plurality of airfoils are the plurality of rotor blades.

The gas turbine engine of any preceding clause, wherein: the pressure sidewall and the suction sidewall extend between the airfoil root and the airfoil tip; and the flared portion includes a flare top face extending from the airfoil tip and a flare bottom face extending from the suction sidewall to an end of the flare top face.

The gas turbine engine of any preceding clause, wherein the flare bottom face defines a concave curve extending from the suction sidewall to the outer flare edge of the flare top face.

The gas turbine engine of any preceding clause, wherein: the flared portion includes a flare sidewall extending between the flare top face and the flare bottom face; and the flare bottom face defines a concave curve extending from the suction sidewall to the flare sidewall.

The gas turbine engine of any preceding clause, wherein the flare bottom face defines a concave curve extending from the suction sidewall and a convex curve extending from the concave curve to the outer flare edge of the flared portion.

The gas turbine engine of any preceding clause, wherein: the plurality of airfoils define an airfoil height extending between the airfoil tip and the airfoil root; the flared portion defines a flare span extending from the airfoil tip towards the airfoil root; and the flare span is greater than or equal to 75% of the airfoil height.

The gas turbine engine of any preceding clause, wherein the flared portion includes a first flare segment and a second flare segment, the first flare segment extending from the flare lead point to a flare point and the second flare segment extending from the flare point towards the trailing edge.

The gas turbine engine of any preceding clause, wherein the maximum of the thickness of the flared portion is at the flare point.

The gas turbine engine of any preceding clause, wherein the maximum of the thickness of the flared portion is greater than 0 and less than or equal to 0.5 times the minimum distance (D_{o_tip}).

The gas turbine engine of any preceding clause, wherein: the thickness of the flared portion extends in a direction perpendicular to the suction sidewall; the thickness of the flared portion increases along the first flare segment from the flare lead point towards the flare point; and the thickness of the flared portion decreases along the second flare segment from the flare point towards the trailing edge.

The gas turbine engine of any preceding clause, wherein: the second flare segment extends from the flare point to an aft edge; the thickness of the flared portion increases along the first flare segment from the flare lead point towards the flare point; and the thickness of the flared portion increases along the second flare segment from the flare point towards the aft edge.

The gas turbine engine of any preceding clause, wherein the second flare segment extends from the flare point to an aft edge, the aft edge extending from the trailing edge perpendicular to the suction sidewall.

The gas turbine engine of any preceding clause, wherein a convex curve is defined between the aft edge and the second flare segment.

The gas turbine engine of any preceding clause, wherein the aft edge extends perpendicular to the second flare segment.

The gas turbine engine of any preceding clause, wherein the second flare segment defines an aft edge of the flared portion, and wherein the aft edge defines a concave curve from the flare point to the trailing edge.

The gas turbine engine of any preceding clause, wherein the outer flare edge of the flared portion defines a generally convex curve between the flare lead point and the trailing edge.

The gas turbine engine of any preceding clause, wherein the plurality of airfoils define a plenum between an inner wall of the pressure sidewall and an inner wall of the suction sidewall.

The gas turbine engine of any preceding clause, wherein: the inner wall of the suction sidewall defines a convex curve.

The gas turbine engine of any preceding clause, wherein the inner wall of the suction sidewall comprises: a first wall portion extending from a base wall of the plenum, the first wall portion parallel to the inner wall of the pressure sidewall; a second wall portion extending from the first wall portion opposite the base wall of the plenum, the second wall portion perpendicular to the first wall portion; and a third wall portion extending from the second wall portion opposite the first wall portion, the third wall portion extending at an angle relative to the second wall portion.

The gas turbine engine of any preceding clause, wherein the flared portion comprises a flare step portion disposed between the suction sidewall and the outer flare edge, the flare step portion comprising: a step sidewall extending perpendicularly from a flare top face; and a step base wall extending perpendicularly from the step sidewall to the outer flare edge; wherein the step sidewall is spaced from the suction sidewall a distance less than the thickness of the flare.

An airfoil for a gas turbine engine, comprising: a leading edge; a trailing edge; a pressure sidewall extending between the leading edge and the trailing edge; a suction sidewall opposite the pressure sidewall and extending between the leading edge and the trailing edge; and a flared portion extending from the suction sidewall, the flared portion extending from a flare lead point towards the trailing edge, wherein the flare lead point is downstream of a throat point on the suction sidewall, and wherein the throat point is at a minimum distance between the suction sidewall of the airfoil and another pressure sidewall of an adjacent airfoil.

The airfoil of any preceding clause, wherein: the airfoil further comprises an airfoil root and an airfoil tip opposite the airfoil root, the pressure sidewall and the suction sidewall extending between the airfoil root and the airfoil tip; and the flared portion includes a flare top face extending from the airfoil tip and a flare bottom face extending from the suction sidewall to an end of the flare top face.

The airfoil of any preceding clause, wherein the flare bottom face defines a concave curve extending from the suction sidewall to an outer flare edge of the flare top face.

The airfoil of any preceding clause, wherein: the flared portion includes a flare sidewall extending between the flare top face and the flare bottom face; and the flare bottom face defines a concave curve extending from the suction sidewall to the flare sidewall.

The airfoil of any preceding clause, wherein the flare bottom face defines a concave curve extending from the suction sidewall and a convex curve extending from the concave curve to an outer flare edge of the flared portion.

The airfoil of any preceding clause, wherein the airfoil further comprises an airfoil root and an airfoil tip opposite the airfoil root; the flared portion defines a flare span extending from the airfoil tip towards the airfoil root; and the flare span is greater than or equal to 75% of a height of the airfoil extending between the airfoil root and the airfoil tip.

The airfoil of any preceding clause, wherein the flared portion includes a first flare segment and a second flare segment, the first flare segment extending from the flare lead point to a flare point and the second flare segment extending from the flare point towards the trailing edge.

The airfoil of any preceding clause, wherein a thickness of the flared portion extends between the suction sidewall and an outer flare edge, and wherein a maximum of the thickness of the flared portion is at the flare point.

The airfoil of any preceding clause, wherein the maximum of the thickness of the flared portion is greater than or equal to 0 and less than or equal to 0.5 times the minimum distance.

The airfoil of any preceding clause, wherein a ratio of the maximum of the thickness of the flared portion over the minimum distance is less than or equal to 1.

The airfoil of any preceding clause, wherein a ratio of the maximum of the thickness of the flared portion over the minimum distance is less than or equal to 0.3.

The airfoil of any preceding clause, wherein: the flared portion includes a flare thickness extending in a direction perpendicular to the suction sidewall; the flare thickness increases along the first flare segment from the flare lead point towards the flare point; and the flare thickness decreases along the second flare segment from the flare point towards the trailing edge.

The airfoil of any preceding clause, wherein: the flared portion includes a flare thickness extending in a direction perpendicular to the suction sidewall; the second flare segment extends from the flare point to an aft edge; the flare thickness increases along the first flare segment from the flare lead point towards the flare point; and the flare thickness increases along the second flare segment from the flare point towards the aft edge.

The airfoil of any preceding clause, wherein the second flare segment extends from the flare point to an aft edge, the aft edge extending from the trailing edge perpendicular to the suction sidewall.

The airfoil of any preceding clause, wherein a convex curve is defines between the aft edge and the second flare segment.

The airfoil of any preceding clause, wherein the aft edge extends perpendicular to the second flare segment.

The airfoil of any preceding clause, wherein the second flare segment defines an aft edge of the flared portion, and wherein the aft edge defines a concave curve from the flare point to the trailing edge.

The airfoil of any preceding clause, wherein an outer flare edge of the flared portion defines a generally convex curve between the flare lead point and the trailing edge.

The airfoil of any preceding clause, wherein the airfoil defines a plenum between an inner wall of the pressure sidewall and an inner wall of the suction sidewall.

The airfoil of any preceding clause, wherein: the inner wall of the suction sidewall defines a convex curve.

The airfoil of any preceding clause, wherein the inner wall of the suction sidewall comprises: a first wall portion extending from a base wall of the plenum, the first wall portion parallel to the inner wall of the pressure sidewall; a second wall portion extending from the first wall portion opposite the base wall of the plenum, the second wall portion perpendicular to the first wall portion; and a third wall portion extending from the second wall portion opposite the first wall portion, the third wall portion extending at an angle relative to the second wall portion.

The gas turbine engine of any preceding clause, wherein the flared portion comprises a flare step portion disposed between the suction sidewall and an outer flare edge, the flare step portion comprising: a step sidewall extending perpendicularly from a flare top face; and a step base wall extending perpendicularly from the step sidewall to the outer flare edge; wherein the step sidewall is spaced from the suction sidewall a distance less than a flare thickness extending between the suction sidewall and the outer flare edge.

A gas turbine engine, comprising: a fan; and a turbomachine operably coupled to the fan for driving the fan, the turbomachine comprising a plurality of airfoils, one or more of the plurality of airfoils comprising the airfoil of any preceding clause.

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

1. A gas turbine engine, comprising:
a fan; and
a turbomachine operably coupled to the fan for driving the fan, the turbomachine comprising a compressor section, a combustion section, and a turbine section disposed in serial flow order along a centerline axis and together defining a working gas flow path, the turbine section comprising a plurality of airfoils extending into the working gas flow path from an airfoil root to an airfoil tip, each airfoil of the plurality of airfoils comprising:
a leading edge, a trailing edge, a pressure sidewall extending between the leading edge and the trailing edge, and a suction sidewall opposite the pressure sidewall and extending between the leading edge and the trailing edge, and
a flared portion extending from the suction sidewall to an outer flare edge, the flared portion extending from a flare lead point towards the trailing edge, wherein the flare lead point is downstream of a throat point on the suction sidewall at the airfoil tip, and wherein the throat point is at a minimum distance (D_{o_tip}) between the suction sidewall of the airfoil and another pressure sidewall of an adjacent airfoil;
wherein the flared portion defines a maximum flare distance (d_{tip_max}) at the airfoil tip, the maximum flare distance (d_{tip_max}) being a maximum of a thickness of the flared portion at the airfoil tip and extending between the suction sidewall and the outer flare edge; and
wherein:
$$1.01 < ( 1 + 30 ln ( [ 1 + \frac{{d}_{tip \_ max}}{{D}_{{o}_{tip}}} ] ) ) - ( 26.4 ( [ 1 + \frac{{d}_{tip \_ max}}{{D}_{{o}_{tip}}} ] - 1 ) ) < 1.24 .$$

2. The gas turbine engine of claim 1, wherein:
$$\frac{{d}_{tip \_ max}}{{D}_{{o}_{tip}}}$$
is greater than or equal to 0.005 (0.5%) and less than or equal to 0.282 (28.2%).

3. The gas turbine engine of claim 1, wherein the turbine section comprises a plurality of stator vanes and a plurality of rotor blades, and wherein the plurality of airfoils are the plurality of rotor blades.

4. The gas turbine engine of claim 1, wherein:
the pressure sidewall and the suction sidewall extend between the airfoil root and the airfoil tip; and
the flared portion includes a flare top face extending from the airfoil tip and a flare bottom face extending from the suction sidewall to an end of the flare top face.

5. The gas turbine engine of claim 4, wherein the flare bottom face defines a concave curve extending from the suction sidewall to the outer flare edge of the flare top face.

6. The gas turbine engine of claim 4, wherein:
the flared portion includes a flare sidewall extending between the flare top face and the flare bottom face; and
the flare bottom face defines a concave curve extending from the suction sidewall to the flare sidewall.

7. The gas turbine engine of claim 4, wherein the flare bottom face defines a concave curve extending from the suction sidewall and a convex curve extending from the concave curve to the outer flare edge of the flared portion.

8. The gas turbine engine of claim 1, wherein:
the plurality of airfoils define an airfoil height extending between the airfoil tip and the airfoil root; and
the flared portion defines a flare span extending from greater than or equal to 75% of the flare span to less than or equal to 100% of the flare span.

9. The gas turbine engine of claim 1, wherein the flared portion includes a first flare segment and a second flare segment, the first flare segment extending from the flare lead point to a flare point and the second flare segment extending from the flare point towards the trailing edge.

10. The gas turbine engine of claim 9, wherein the maximum of the thickness of the flared portion is at the flare point.

11. (canceled)

12. The gas turbine engine of claim 9, wherein:
the thickness of the flared portion extends in a direction perpendicular to the suction sidewall;
the thickness of the flared portion increases along the first flare segment from the flare lead point towards the flare point; and
the thickness of the flared portion decreases along the second flare segment from the flare point towards the trailing edge.

13. The gas turbine engine of claim 9, wherein:
the second flare segment extends from the flare point to an aft edge;
the thickness of the flared portion increases along the first flare segment from the flare lead point towards the flare point; and
the thickness of the flared portion increases along the second flare segment from the flare point towards the aft edge.

14. The gas turbine engine of claim 9, wherein the second flare segment extends from the flare point to an aft edge, the aft edge extending from the trailing edge perpendicular to the suction sidewall.

15. The gas turbine engine of claim 14, wherein a convex curve is defined between the aft edge and the second flare segment.

16. The gas turbine engine of claim 14, wherein the aft edge extends perpendicular to the second flare segment.

17. The gas turbine engine of claim 9, wherein the second flare segment defines an aft edge of the flared portion, and wherein the aft edge defines a concave curve from the flare point to the trailing edge.

18. The gas turbine engine of claim 1, wherein the outer flare edge of the flared portion defines a generally convex curve between the flare lead point and the trailing edge.

19. The gas turbine engine of claim 1, wherein the plurality of airfoils define a plenum between an inner wall of the pressure sidewall and an inner wall of the suction sidewall.

20. The gas turbine engine of claim 1, wherein the flared portion comprises a flare step portion disposed between the suction sidewall and the outer flare edge, the flare step portion comprising:
a step sidewall extending perpendicularly from a flare top face; and
a step base wall extending perpendicularly from the step sidewall to the outer flare edge;
wherein the step sidewall is spaced from the suction sidewall a distance less than the thickness of the flared portion.

21. The gas turbine engine of claim 1, wherein the thickness of the flared portion at the flare lead point is 0.
